(19) United States
(12) Patent Application Publication
(10) Pub. No.: US 2021/0143639 A1
(43) Pub. Date: May 13, 2021

(54) SYSTEMS AND METHODS OF AUTONOMOUS VOLTAGE CONTROL IN ELECTRIC POWER SYSTEMS

(71) Applicants: Global Energy Interconnection Research Institute Co. Ltd, Beijing (CN); State Grid Corporation of China Co. Ltd, Beijing (CN); State Grid Jiangsu Electric Power Co., LTD., Nanjing (CN); State Grid ShanXi Electric Power Company, Jinan (CN)

(72) Inventors: Jiajun Duan, San Jose, CA (US); Shengyi Wang, San Jose, CA (US); Di Shi, San Jose, CA (US); Ruisheng Diao, San Jose, CA (US); Bei Zhang, San Jose, CA (US); Xiao Lu, San Jose, CA (US)

(21) Appl. No.: 17/091,587

(22) Filed: Nov. 6, 2020

Related U.S. Application Data
(60) Provisional application No. 62/933,194, filed on Nov. 8, 2019.

(51) Int. Cl. H02J 3/00; G05B 13/02; H02J 3/24

(52) U.S. Cl. CPC H02J 3/0012; H02J 2203/20; H02J 3/242; G05B 13/027

(57) ABSTRACT

Systems and methods for autonomous voltage control in an electric power system are disclosed which include acquiring state information at buses of the electric power system, detecting a state violation from the state information, generating a first action setting based on the state violation using a deep reinforcement learning (DRL) algorithm by a first artificial intelligent (AI) agent assigned to a first region of the electric power system where the state violation occurs, and maintaining a second action setting by a second AI agent assigned to a second region of the electric power system where no substantial state violation is detected.

### CROSS-REFERENCE TO RELATED APPLICATIONS

This application claims the benefit of and priority to U.S. Provisional Application No. 62/933,194 filed on 8 Nov. 2019 and entitled “A Data-driven Multi-agent Autonomous Voltage Control Framework based on Deep Reinforcement Learning,” and is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, GEIRI North America, All Rights Reserved.

### FIELD OF TECHNOLOGY

The present disclosure generally relates to electric power transmission and distribution system, and, more particularly, to systems and methods of autonomous voltage control for electric power systems.

### BACKGROUND OF TECHNOLOGY

Power generation systems, often in remote locations, generate electric power which is transmitted to distribution systems via transmission systems. The transmission systems transmit electric power to various distribution systems which may be coupled further to one or more utilities with various loads. The power generation systems, the transmission systems and the distribution systems, together with the loads, are integrated with each other structurally and operationally and creates a complex electric power network. The complexity and dynamism of the electric power network requires an automated approach which helps to reduce losses and increase reliability.

With the increasing integration of renewable energy farms and various distributed energy resources, fast demand response and voltage regulation of modern power grids are facing great challenges such as the voltage quality degradation, cascading tripping faults, and voltage stability issues. In recent decades, various autonomous voltage control (AVC) methods have been developed to better tackle such challenges. An objective of AVC is to maintain bus magnitudes within a desirable range by properly regulating control settings such as generator bus voltage magnitudes, capacitor bank switching, and transformer tap setting, etc.

Based on the implementation mechanism, the existing work of AVC can be categorized into three categories: centralized control, distributed control, and decentralized control. The centralized control strategy requires sophisticated communication networks to collect global operating conditions and requires a powerful central controller to process a huge amount of information. As one of the centralized solutions, the optimal power flow (OPF) based method has been extensively implemented to support the system-wide voltage profile such as Q. Guo, H. Sun, M. Zhang et al., “Optimal voltage control of pjm smart transmission grid: Study, implementation, and evaluation,” IEEE Transactions on Smart Grid, vol. 4, no. 3, pp. 1665-1674, September 2013 and N. Qin, C. L. Bak et al., “Multi-stage optimization-based automatic voltage control systems considering wind power forecasting errors,” IEEE Transactions on Power Systems, vol. 32, no. 2, pp. 1073-1088, 2016. These methods use convex relax technique to handle nonlinear and non-convex problems.

However, such OPF-based methods are susceptible to single point failure, communication burden, and scalability issues. As an alternative solution, the distributed or decentralized control strategy has attracted more and more attention to mitigating disadvantages in the centralized control strategy according to D. K. Molzahn, F. Dörfler et al., “A survey of distributed optimization and control algorithms for electric power systems,” IEEE Transactions on Smart Grid, vol. 8, no. 6, pp. 2941-2962, 2017 and K. E. Antoniadou-Plytaria, I. N. Kouveliotis-Lysikatos et al., “Dis-tributed and decentralized voltage control of smart distribution networks: Models, methods, and future research,” IEEE Transactions on smart grid, vol. 8, no. 6, pp. 2999-3008, 2017. Both above solutions do not require a central controller, but the former method asks neighboring agents to share a certain amount of information, while the latter one only uses the local measurements without neighboring communication at all in a multi-agent system. For example, the alternating direction method of multipliers (ADMM) algorithm is used to develop a distributed voltage control scheme in H. J. Liu, W. Shi, and H. Zhu, “Distributed voltage control in distribution networks: Online and robust implementations,” IEEE Transactions on Smart Grid, vol. 9, no. 6, pp. 6106-6117, November 2018, to achieve the globally optimal settings of reactive power. A paper, H. Zhu and H. J. Liu, “Fast local voltage control under limited reactive power: Optimality and stability analysis,” IEEE Transactions on Power Systems, vol. 31, no. 5, pp. 3794-3803, September 2016, presents a gradient-projection based local reactive power (VAR) control framework with a guarantee of convergence to a surrogate centralized problem.

Although majority of existing work have been claimed to achieve promising performance in AVC, they heavily rely on accurate knowledge of power grids and parameters, which is not practical for nowadays' large interconnected power systems with increasing complexity. In order to eliminate this dependency, a few researchers have developed reinforcement learning (RL) based AVC methods that allow controllers to learn a goal-oriented control scheme from interactions with a system-like simulation model driven by a large amount of operating data. See M. Glavic, R. Fonteneau, and D. Ernst, “Reinforcement learning for electric power system decision and control: Past considerations and perspectives,” IFAC-PapersOnLine, vol. 50, no. 1, pp. 6918-6927, 2017. A model-free Q-learning algorithm is used in J. G. Vlachogiannis and N. D. Hatziargyriou, “Reinforcement learning for reactive power control,” IEEE transactions on power systems, vol. 19, no. 3, pp. 1317-1325, 2004 to provide the optimal control setting, which is the solution of the constrained load flow problem. The authors in V. Mnih, K. Kavukcuoglu et al., “Human-level control through deep reinforcement learning,” Nature, vol. 518, no. 7540, p. 529, 2015, propose a fully distributed method for optimal reactive power dispatch using a consensus-based Q-learning algorithm. Recently, the deep reinforcement learning (DRL) has been largely recognized by the research community because of its superior ability to represent continuous high-dimensional space. A novel AVC paradigm, called Grid Mind, is proposed to correct the abnormal voltage profiles in R. Diao, Z. Wang, S. Di et al., “Autonomous voltage control for grid operation using deep reinforcement learning,” IEEE PES General Meeting, Atlanta, Ga., 2019, 2019, and J. Duan, D. Shi, R. Diao et al., “Deep-reinforcement-learning-based autonomous voltage control for power grid operations,” IEEE Transactions on Power Systems, Early Access 2019 using DRL. The policy for optimal tap setting of voltage regulation transformers is found by a batch RL algorithm in H. Xu, A. D. Dominguez-Garcia, and P. W. Sauer, “Optimal tap setting of voltage regulation transformers using batch reinforcement learning,” arXiv preprint arXiv:1807.10997, 2018. The paper, Q. Yang, G. Wang et al., “Real-time voltage control using deep reinforcement learning,” arXiv preprint arXiv:1904.09374, 2019, proposes a novel two-timescale solution, where the deep Q network method is applied to the optimal configuration of capacitors on the fast time scale.

As such, what is desired is effective voltage control systems and methods implemented in a decentralized and data-driven fashion for a large-scale electric power system.

### SUMMARY OF DESCRIBED SUBJECT MATTER

The presently disclosed embodiments relate to systems and methods for autonomous voltage control in electric power systems.

In some embodiments, the present disclosure provides an exemplary technically improved computer-based autonomous voltage control system and method which includes acquiring state information at buses of the electric power system, detecting a state violation from the state information, generating a first action setting based on the state violation using a deep reinforcement learning (DRL) algorithm by a first artificial intelligent (AI) agent assigned to a first region of the electric power system where the state violation occurs, and maintaining a second action setting by a second AI agent assigned to a second region of the electric power system where no substantial state violation is detected.

In some embodiments, the present disclosure provides an exemplary technically improved computer-based autonomous voltage control system and method that include adjusting a partition of the electric power system by allocating a first bus from the first region to a third region of the plurality of regions, wherein the first bus is substantially uncontrollable by local resources in the first region and substantially controllable by local resources in the third region.

In some embodiments, the present disclosure provides an exemplary technically improved computer-based autonomous voltage control system and method that include a training process comprising obtaining a first power flow file of the electric power system at a first time step, obtaining an initial grid state from the first power flow file using a power grid simulator, determining the state violation based on a deviation by the state information from the initial grid state, generating a first suggested action based on the state violation, executing the first suggested action in the power grid simulator to obtain a new grid state, calculating and evaluating with a reward function according to the new grid state, and determining if the state violation is solved, wherein if the state violation is solved, the training process obtains a second power flow file at a second time step for another round of training process, and if the state violation is not solved, the training process generates a second suggested action by an updated version of the first AI agent.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1-20 show one or more schematic flow diagrams, certain computer-based architectures, and/or computer-generated plots which are illustrative of some exemplary aspects of at least some embodiments of the present disclosure.

FIG. 1A, FIG. 1B, and FIG. 1C demonstrate a heuristic method to partition agent.

FIG. 2 illustrates information flow in a DRL agent training process of an embodiment of the presently disclosed MA-AVC method.

FIG. 3 shows an example for decentralized execution under heavy load condition.

FIG. 4 shows a flowchart illustrating a MA-AVC process for an electric power system according to an embodiment of the present disclosure.

FIG. 5 shows a flowchart illustrating a power grid partitioning process of the MA-AVC process of FIG. 4.

FIG. 6 shows a flowchart illustrating a DRL training process for the MA-AVC process of FIG. 4.

FIG. 7 illustrates a neural network architecture of (target) actor, (target) critic, and coordinator for each agent.

FIG. 8 shows an actor and critic loss for case 1 of the numerical simulation.

FIG. 9 shows reward and action time for case 1 of the numerical simulation.

FIG. 10 shows a level of cooperation for case 1 of the numerical simulation.

FIG. 11 shows a CPU time for case 1 of the numerical simulation.

FIG. 12 shows an actor and critic loss for case 2 of the numerical simulation.

FIG. 13 shows reward and action time for case 2 of the numerical simulation.

FIG. 14 shows a level of cooperation for case 2 of the numerical simulation.

FIG. 15 shows a CPU time for case 2 of the numerical simulation.

FIG. 16 shows an actor and critic loss for case 3 of the numerical simulation.

FIG. 17 shows reward and action time for case 3 of the numerical simulation.

FIG. 18 shows a level of cooperation for case 3 of the numerical simulation.

FIG. 19 shows a CPU time for case 3 of the numerical simulation.

FIG. 20 illustrates the effect of reward on learning.

### DETAILED DESCRIPTION

The present disclosure relates to data-driven multi-agent systems and methods of autonomous voltage control framework based on deep reinforcement learning. Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

In present disclosure, a novel multi-agent AVC (MA-AVC) scheme is proposed to maintain voltage magnitudes within their operation limits. First, a heuristic method is developed to partition agents with the two steps including geographic partition and post-partition adjustment in a way of trial and error. Then, the whole system can be divided into several small regions. Second, the MA-AVC problem is formulated as a Markov Game with a bi-layer reward design considering the cooperation level. Third, a multi-agent deep deterministic policy gradient (MADDPG) algorithm, which is a multi-agent, off-policy and actor-critic DRL algorithm, is modified and reformulated for the AVC problem. During the training process, a centralized communication network is required to provide global information for critic network updating. One notable thing is this process can be achieved offline in a safe lab environment without interaction with a real system. During execution, the well-learned DRL agent only takes the local measurements, and the output control commands can be verified by the grid operator before executing. Finally, a coordinator approximator is developed to adaptively learn the cooperation level among different agents defined in the reward function. In addition, an independent replay buffer is assigned to each agent to stabilize the MADDPG system. Contributions to the art of AVC by the embodiments of the present disclosure can be summarized as follows.

The DRL-based agent in the proposed MA-AVC scheme can learn its control policy through massive offline training without needs to model complicated physical systems and adapt its behavior to new changes including load/generation variations and topological changes, etc.

The proposed multi-agent DRL system solves the dimension cursing problem in existing DRL methods and can be scaled up to control large-scale power systems accordingly. The proposed control scheme can also be easily extended and applied to other control problems beyond AVC.

The decentralized execution mechanism in the proposed MA-AVC scheme can be applied to large-scale intricate energy networks with low computational complexity for each agent. Meanwhile, it addresses the communication delay and the single-point failure issue of the centralized control scheme.

The proposed MA-AVC scheme realizes a regional control with an operation rule based policy design, and refines the original MADDPG algorithm integrated with independent replay buffers to stabilize the learning process and coordinators to model the cooperation behavior, and tests the robustness of the algorithm to a weak centralized communication environment.

The present disclosure is divided into three sections. Section I introduces the definition of Markov Game and formulates the AVC problem as a Markov Game. Section II presents a MADDPG and proposes a data-driven multi-agent AVC (MA-AVC) scheme including offline training and online execution. Section III presents numerical simulation using Illinois 200-Bus system.

Section I. Problem Formulation

In this section, the preliminaries for Markov Games are introduced first, and then the AVC problem is formulated as a Markov Game.

A. Preliminaries of Markov Games

A multi-agent extension of Markov decision processes (MDPs) can be described by Markov Games. It can also be viewed as a collection of coupled strategic games, one per state. At each time step t, a Markov Game for Na agents is defined by a discrete set of states s^{t} ∈S, a discrete set of actions aᵢ^{t}∈Aᵢ and a discrete set of observations oᵢ^{t}∈Oᵢ for each agent. If a current observation oᵢ^{t} of each agent completely reveals the current state of the environment, that is, s^{t}=oᵢ^{t}, the game is a fully observable Markov Game, otherwise it is a partially observable Markov Game. The present disclosure is focused on the latter. To select actions, each agent has its individual policy πᵢ: Oᵢ×Aᵢ→[0, 1], which is a mapping πᵢ(oᵢ^{t}) from the observation to an action. When each agent takes its individual action, the environment changes as a result of the joint action at a^{t}∈A(=xᵢ₌₁^{N}^{ₐ} Aᵢ) according to the state transition model p(s^{t+1}|s^{t}, a^{t}). Each agent obtains rewards as a function of the state and the joint action rᵢ^{t}: S×A→ [symbol] and receives a private observation oᵢ^{t+1} conditioned on the observation model p(oᵢ^{t+1}|s^{t}). The goal of each agent is to find a policy, which maximizes its expected discounted return

$$\begin{matrix}\begin{matrix}{max}_{{}_{i}} & {E}_{{{a}_{i}^{t} ∼ {}_{i}}_{{s}^{t + 1} ∼ p ( {s}^{t + 1} \vert {s}^{t} , {a}^{t} )}}\end{matrix} & [ {\sum }_{t = 0}^{T} {γ}^{t} {r}_{i}^{t} ]\end{matrix} \qquad ( 1 )$$

Where γ∈ [0, 1] is a discount factor and T is the time horizon.

Finally, two important value functions (2) and (3) of each agent i (state-value function Vᵢ(s) and action value function Qᵢ(s, a) are defined as follows

$$\begin{matrix}{V}_{i} ( s ) ≐ {𝔼}_{{{a}_{i}^{t} ∼ {}_{i}}_{{s}^{t + 1} ∼ p ( {s}^{t + 1} \vert {s}^{t} , {a}^{t} )}} [ {\sum }_{t = 0}^{T} {γ}^{t} {r}_{i}^{t} \vert {s}_{0} = s ] & ( 2 ) \\ {Q}_{i} ( s , a ) ≐ {𝔼}_{{{a}_{i}^{t} ∼ {}_{i}}_{{s}^{t + 1} ∼ p ( {s}^{t + 1} \vert {s}^{t} , {a}^{t} )}} [ {\sum }_{t = 0}^{T} {γ}^{t} {r}_{i}^{t} \vert {s}_{0} = s , {a}_{0} = a ] & ( 3 )\end{matrix}$$

where, Vᵢ(s) represents the expected return when starting in s and following πᵢ, thereafter, while Qᵢ(s, a) represents the expected discounted return when starting from taking action a in state s under a policy πᵢ thereafter.

B. Formulating AVC Problem as a Markov Game

For AVC, the control goal is to bring the system voltage profiles back to normal after unexpected disturbances, and the control variables include generator bus voltage magnitude, capacitor bank switching and transformer tap setting, etc. In embodiments, phasor measurement units (PMU) and supervisory control and data acquisition (SCADA) systems are used to measure bus voltage magnitude. The PMUs and/or SCADAs are connected to the buses. The measurements at the various PMUs and/or SCADAs may be synchronized by a common time source usually provided by the GPS. With such a system, synchronized real-time measurements of multiple remote points on a power grid becomes possible.

1) Definition of Agent:

According to an embodiment of the present disclosure, a heuristic method to partition multiple control agents is proposed. First, the power grid is divided into several regional zones according to the geographic location information. Then, each agent is assigned with a certain number of inter-connected zones (geographic partition). Because the geographic partition cannot guarantee that each bus voltage is controllable through regulating the local generator bus voltage magnitudes. Next, the uncontrollable sparse buses are recorded and re-assigned to other effective agents (post-partition adjustment), which is implemented in a way of trial and error. Specifically speaking, after geographic partition, an offline evaluating program will be set up, and the uncontrollable buses will be recorded during this process. Then the uncontrollable buses in the records will be re-assigned to other agents that have the electrical connections. The above post-partition adjustment process will be repeatedly implemented until all of the buses are under control by local resources.

FIG. 1A, FIG. 1B, and FIG. 1C demonstrate a heuristic method to partition agents. In this demonstration, the heuristic method is applied to an electric power grid system 102, which as a plurality of clusters of loads 110. Referring to FIG. 1A, an example of such electric power grid system 102 is the Illinois 200-bus system, which has six default zones denoted by zone A-zone F. Referring to FIG. 1B in conjunction with FIG. 1A, initially, zones A and F are assigned to agent 1; zones B and C are assigned to agent 2; and zones D and E are assigned to agent 3. It should be noted that the way of partition may not be unique. According to offline simulated records, the noted uncontrollable buses are re-assigned among agents 1 to 3. After the partition, zone D is separated into three different subzones, namely D1, D2 and D3, in which 14 out of 15 uncontrollable buses (bus #41, #80, #111, #163, #164, #165, #166, #168, #169, #173, #174, #175, #179, #184, i.e., subzone D1) are re-assigned from agent 3 to agent 1, and the remaining one uncontrollable bus (bus #100, i.e., subzone D2) is re-assigned from agent 3 to agent 2. In the end, agent 1 is responsible for zones A, F and D1; agent 2 is responsible for zones B, C and D2; and agent 3 is responsible for zones E and D3 as shown in FIG. 1C in conjunction with FIG. 1A.

2) Definition of Action, State and Observation:

The control actions are defined as a vector of generator bus voltage magnitudes, each element of which can be continuously adjusted within a range from 0.95 pu to 1.05 pu. The states are defined as a vector of meter measurements that are used to represent system operation status, e.g., system-wide bus voltage magnitudes, phase angles, loads, generations and power flows. On the one hand, other system operation status can be somehow reflected on the voltage profile. On the other hand, it also reflects how powerful DRL is in extracting the useful information from the limited states. In this way, many resources for measurement and communication can be saved. Three voltage operation zones are defined to differentiate voltage profiles including normal zone (Vₖ^{t}∈ [0.8, 0.95)∪(1.05, 1.25] pu), and diverged zone Vₖ^{t}∈ [0, 0.8)∪(1.25, ∞] pu). The observation for each agent is defined as a local measurement of bus voltage magnitudes. It is assumed that each agent can only observe and manage its own zones.

3) Definition of Reward:

To implement DRL, the reward function is designed to evaluate the effectiveness of the actions, which is defined through a hierarchical consideration. First, for each bus, the reward rᵢₖ^{t} is designed to motivate the agent to reduce the deviation of bus voltage magnitude from the given reference value V_{ref}=1.0 pu. A complete definition for rᵢₖ^{t} is illustrated in Table I below.

Table I
A Definition of Reward of Each Bus

| Operation | | | rᵢₖ^{t}'s monotone |
|---|---|---|---|
| zone | Vₖ^{t} (pu) | rᵢₖ^{t} | when Vₖ^{t} → 1.0 pu |
| Normal | [V_{ref}, 1.05] | $\frac{1.05 - {V}_{k}^{t}}{1.05 - {V}_{ref}}$ | 0 → 1 |
| Normal | [0.95, V_{ref}) | $\frac{{V}_{k}^{t} - 0.95}{{V}_{ref} - 0.95}$ | 0 → 1 |
| Violation | (1.05, 1.25] | $\frac{{V}_{k}^{t} - {V}_{ref}}{1.25 - {V}_{ref}}$ | −1 → −0.2 |
| Violation | [0.8, 0.95) | $\frac{{V}_{ref} - {V}_{k}^{t}}{{V}_{ref} - 0.8}$ | −1 → −0.25 |
| Diverged | [1.25, ∞) | −5 | No change |
| Diverged | [0, 0.8) | −5 | No change |

It can be seen that buses with smaller deviations will be awarded larger rewards. Then, for each agent, the total reward of each transition is calculated according to three different occasions: i) if all of the voltages are located in the normal zone, each agent is rewarded with the value as calculated in Equation (4); ii) if the violation exists in any agent without the divergence, each agent is penalized with value shown as Equation (5); iii) if the divergence exists in any agents, each agent is penalized with a relatively large constant in Equation (6).

$$\begin{matrix}{r}_{i}^{t} = \frac{{Σ}_{k ∈ {B}_{i}} {r}_{ik}^{t} + {Σ}_{j \neq i } {Σ}_{k ∈ {B}_{j}} {r}_{jk}^{t}}{{n}_{i}^{b} + {\sum }_{j \neq i} {n}_{j}^{b}} ∈ [ 0 , 1 ] \\ & ( 4 ) \\ {r}_{i}^{t} = α [ {\sum }_{k ∈ {Λ}_{i}^{t}} {r}_{ik}^{t} + {β}_{i}^{t} {\sum }_{j \neq i} {\sum }_{k ∈ {Λ}_{j}^{t}} {r}_{jk}^{t} ] & ( 5 ) \\ {r}_{i}^{t} = - 5 & ( 6 )\end{matrix}$$

where Bᵢ is the set of local bus index that the agent i has, and nᵢ^{b} is the number of buses that the agent i has. α is the parameter for scaling, Λᵢ^{t} is the set of violated bus index that the agent i has, and βᵢ^{t}∈ [0, 1] is the parameter to reflect the level of cooperation to fix the system voltage violation issues. When Åᵢ^{t}=Ø, rᵢₖ^{t}=0 (k∈Aᵢ^{t}).

It should be noted that in the first and the third situation, each agent has the same reward, while in the occasion ii), if βᵢ^{t}=1, all of the agents share the same reward and collaborate to solve the bus voltage violations of the whole system, and when βᵢ^{t} approaches 0, each agent considers more about its own regional buses and cares less for other zones.

Section II. Data-Driven Multi-Agent AVC Scheme

In the previous section, the MA-AVC problem has been formulated as a Markov Game. Thus, one critical problem of solving Equation (1) is to design an agent to learn an effective policy (control law) through interaction with the environment. One of the desired features for a suitable DRL algorithm is that it may utilize extra information to accelerate the training process, while only the local measurements are required (i.e., observations) during execution. In this section, a multi-agent, off-policy and actor-critic DRL algorithm, i.e., MADDPG, is first briefly introduced. Then, a novel MA-AVC scheme is developed based on the extension and modification of MADDPG. The proposed method occupies the attributes such as data-driven, centralized-training (even if in some weak communication environment during training), decentralized-executing, and operation-rule-integrated, which can meet the desired criteria of modern power grid operation.

A. MADDPG

Considering a deterministic parametric policy called actor denoted by πᵢ(·|θᵢ^{π}) Oᵢ→Aᵢ approximated by a neural network for agent i, the control law for each agent with a Gaussian noise N(0, σᵢ^{t}) can be expressed as

aᵢ^{t}=πᵢ(oᵢ^{t}|θᵢ^{t})+N(0,σᵢ^{t}) (7)

where θᵢ^{π} is the weights of actor for agent i, and σᵢ^{t} is a parameter for exploration. For the episodic case, the performance measure of policy J(θᵢ^{π}) for agent i can be defined as the value function of the start state of the episode

J(θᵢ^{π})=Vᵢ(s⁰) (8)

According to policy improvement, the actor can be updated by implementing gradient ascent to move the policy in the direction of gradient of Equation (8), which can be viewed as maximizing action-value function, and an analytic expression of gradient can be written as follows

∇_{θ}_{ᵢ}_{^{π}}J(θᵢ^{π})≈*Eₛ_{^{t}}_{˜D}[∇_{θ}_{ᵢ}_{^{π}}Qᵢ(s^{t},aᵢ^{t}=πᵢ(oᵢ^{t}|θᵢ^{π}),a₋ᵢ^{t})] (9)

where D is the replay buffer which stores historical experience, and a₋ᵢ^{t} is the other agents' actions. At each time step, the actor and critic for each agent can be updated by sampling a minibatch uniformly from the buffer, which allows the algorithm to benefit from learning across a set of uncorrelated experiences to stabilize the learning process. Without a replay buffer, the gradient ∇_{θ}_{ᵢ}_{^{π}}J(θᵢ^{π}) in Equation (8) will be calculated using sequential samples, which may always have the same direction in the gradient and lead to the divergence of learning.

Applying the chain rule to Equation (9), the gradient of Equation (8) can be decomposed into the gradient of the action-value with respect to actions, and the gradient of the policy with respect to the policy parameters

∇_{θ}_{ᵢ}_{^{π}}J(θᵢ^{π})=*Eₛ_{^{t}}_{˜D}[∇ₐ_{ᵢ}_{^{t}}Qᵢ(s^{t},aᵢ^{t},a₋ᵢ^{t})∇_{θ}_{ᵢ}_{^{π}}aᵢ^{t}|ₐ_{ᵢ}_{^{t}}_{=π}_{ᵢ}₍ₒ_{ᵢ}_{^{t}}_{|θ}_{ᵢ}_{^{π}}₎] (10)

It should be noted that the action-value Qᵢ(s^{t}, aᵢ^{t}, a₋ᵢ^{t}) is a centralized policy evaluation function considering not only agent i's own actions, but also other agents' actions, which helps to make a stationary environment for each agent, even as the policies change. In addition, we have s^{t}=(oᵢ^{t}, o₋ᵢ^{t}), but actually there is no restrictions to its setting.

The process to learn an action-value function is called policy evaluation. Considering a parametric action-value function called critic denoted by Qᵢ(•|θᵢ^{Q}) approximated by a neural network for agent i, the action-value function can be updated by minimizing the following loss

L(θᵢ^{Q})=*Eₛ_{^{t}}_{˜D}[(Qᵢ(s^{t},aᵢ^{t},a₋ᵢ^{t}|θᵢ^{Q})−yᵢ^{t})²] (11)

where

yᵢ^{t}=rᵢ^{t}+γQᵢ(s^{t+1},aᵢ^{t+1},a₋ᵢ^{t+1}|θᵢ^{Q}) (12)

where θᵢ^{Q} is the weights of critic for agent i. In order to improve the stability of learning, target networks for actor and critic denoted by π′ᵢ(•|θᵢ^{π′}) and Q′ᵢ(•|θᵢ^{Q′}) are introduced in T. P. Lillicrap, J. J. Hunt et al., “Continuous control with deep reinforcement learning,” arXiv preprint arXiv:1509.02971, 2015, where θᵢ^{π′} and θᵢ^{Q′} are the weights of target actor and target critic, respectively. The target value yᵢ^{t} is a reference value that the critic network of Qᵢ(•|θᵢ^{Q}) wants to track during the training. This value is estimated by target networks of by π′ᵢ(•|θᵢ^{π′}) and Q′ᵢ(•|θᵢ^{Q′}). Then the yᵢ^{t} is stabilized and replaced by target networks

yᵢ^{t}=rᵢ^{t}+γQ′ᵢ(s^{t+1},aᵢ^{t+1′},a₋ᵢ^{t+1′}|θᵢ^{Q′})|ₐ_{ᵢ}_{^{t+1′}}_{=π′}_{ᵢ}₍ₒ_{ᵢ}_{^{t+1}}₎) (13)

The weights of these target networks for agent i are updated by having them slowly track the learned networks (actor and critic)

θᵢ^{Q′}←τθᵢ^{Q}+(1−τ)θᵢ^{Q′} (14)

θᵢ^{π′}←τθᵢ^{π}+(1−τ)θᵢ^{π′} (15)

where τ«1 is a parameter for updating the target networks.

B. MA-AVC Scheme

From (5), it can be seen that the proposed reward in the second situation requires to set the parameter βᵢ^{t} to reflect the level of cooperation. It can be set manually as a constant, but in this work a coordinator denoted by fᵢ(•|θᵢ^{β}): S→ [symbol] approximated by a neural network for agent i is proposed to adaptively regulate it, and the parameter βᵢ^{t} can be calculated as

βᵢ^{t}=fᵢ(s^{t}|θᵢ^{β}) (16)

where θᵢ^{β} is the weights of coordinator for agent i. It can be seen that the parameter βᵢ^{t} is determined by the system states. In this work, the coordinator is updated by minimizing the critic loss with respect to the coordinator weights, and its gradient can be expressed as

$${∇}_{{θ}_{i}^{β}} L ( {θ}_{i}^{β} ) = {2}^{*} {E}_{{s}^{t} ∼ D} [ {\sum }_{j \neq i} {\sum }_{k ∈ {Λ}_{j}^{t}} {r}_{jk}^{t} {∇}_{{θ}_{i}^{β}} {β}_{i}^{t} ] \qquad ( 17 )$$

It is expected that the critic can evaluate how good the parameter βᵢ^{t} is during training, and the learned parameter βᵢ^{t} can be a good predictor of the cooperation level for the next time step.

Conventionally, it is desired to regulate the generators in the abnormal voltage areas, while maintaining the original setting of the generators in the other normal areas. In order to integrate operation rules into MADDPG, an indication function g(•): [symbol] →{0, 1} is defined as

$${a}_{i}^{t} = \{ \begin{matrix}{π}_{i} ( {o}_{i}^{t} \vert {θ}_{i}^{π} ) + N ( 0 , {σ}_{i}^{t} ) & if \vert {Λ}_{i}^{t} \vert > 0 ; \\ {a}_{i}^{t - 1} & if \vert {Λ}_{i}^{t} \vert = 0 .\end{matrix} \qquad ( 18 )$$

where |Λᵢ^{t}| is the number of violated bus that the agent i has. In order to make the learning more stable, each agent has its own replay buffer denoted by Dᵢ which can store the following transitions

Dᵢ←(s^{t},oᵢ^{t},a^{t},rᵢ^{t},s^{t+1},oᵢ^{t+1},a₋ᵢ^{t+1′}) (19)

where a^{t}=(aᵢ^{t}, a₋ᵢ^{t}) and a^{t+1′}=(aᵢ^{t+1′}, a₋ᵢ^{t+1′}). This is done to make the samples more identically distributed.

Incorporating Equations (10)-(11) and (13)-(19), the MA-AVC scheme according to embodiments of the present disclosure is summarized in algorithm 1 for training and algorithm 2 for execution.

C. Training and Execution

In order to mimic the real power system in a lab, a power flow solver environment in algorithm 1 is used. Each agent has its individual actor, critic, coordinator, and replay buffer. But they can share a certain amount of information during the training process.

Algorithm I: The MA-AVC Algorithm for Training

| | |
|---|---|
| 1: | for episode = 1 to M do |
| 2: | Initialize power flow and send oᵢ^{t}, s^{t} to each agent |
| 3: | Count \|Λᵢ^{t}\| |
| 4: | while voltages violate and step < N do |
| 5: | Calculate aᵢ^{t} based on equation (18) |
| 6: | Execute aᵢ^{t} in power flow solver environment and |
| | send a^{t}, s^{t+1}, rᵢ^{t} to each agent |
| 7: | Based on a^{t}, s^{t+1}, rᵢ^{t}, selects a^{t+1}′ using target actor |
| 8: | Congregate all aᵢ^{t+1}′, and share a^{t+1}′ to each agent |
| 9: | Store transitions in Dᵢ for each violated agent i |
| 10: | Update actor (10), critic (11), and coordinator of |
| | violated agents (17) with a randomly sampled |
| | minibatch |
| 11: | Update target critic and actor (14) and (15) |
| 12: | reduce noise σᵢ^{t} |
| 13: | step += 1 |
| 14: | end while |
| 15: | end for |

Algorithm 2: The MA-AVC Algorithm for Execution

| | |
|---|---|
| 1: | repeat |
| 2: | Detect Voltage violations of each agent, and count \|Λᵢ^{t}\| |
| 3: | Select aᵢ^{t} (18) with extremely small σᵢ^{t} |
| 4: | Execute aᵢ^{t} in the environment |
| 6: | until voltage violations are cleared |

In Algorithm 1, the values of M and N are the size of the training dataset and the maximum number of iterations, respectively. The size of the training dataset should be large enough so that the training dataset can contain more system operation statuses. The maximum number of iterations should not be too large to reduce the negative impact on training due to consequential transitions with ineffective actions.

FIG. 2 illustrates information flow in a DRL agent training process of an embodiment of the presently disclosed MA-AVC method. The detailed training and implementation process can be summarized as follows.

Step 1. For each power flow file 220 (with or without contingencies 250) as an episode, the environment (grid simulator) will solve the power flow and obtain the initial grid states in step 202. Based on the states, if agents detect any voltage violations, the observation of each of the agents 212, 214 and 218 will be extracted. Otherwise, move to the next episode (i.e., redo step 1).

Step 2. The non-violated DRL agents 212, 214 and 218 will maintain the original action setting, while the violated DRL agents 212, 214 and 218 will execute new actions based on Equation (18). Then, new grid states will be obtained from the environment using the modified power flow file 220 through the power flow solver 230. According to the obtained new states, the reward and the new observation of each agent will be calculated and extracted, respectively.

Step 3. Each violated agent 212, 214 and 218 will store the transitions in their individual replay buffer. Periodically, the actor, critic and coordinator network will be updated in turn with a randomly sampled minibatch.

Step 4. Along with the training, each of the DRL agent 212, 214 and 218 keeps reducing the noise to decrease the exploration probability. If one of the episode termination conditions is satisfied, store the information and go to the next episode (i.e., redo Step 1).

The above closed-loop process will continue until all of the episodes in the training dataset run out. For each episode, the training process terminates in step 240 when one of three conditions is satisfied: i) violation cleared; ii) divergent power flow solution; iii) 240 the maximum number of iterations reached. This closed-loop process will continue until one of the episode termination conditions is satisfied. It does not matter whether voltage violation still exists if the episode is terminated under the condition i) and ii). Through the penalization mechanism designed in the reward and penalty, the agents 212, 214 and 218 can learn from the experience to avoid the bad termination conditions.

During online execution, the actor of controllers will only utilize the local measurement from the power grids. At the beginning stage of online implementation, the decisions from the DRL agent will be firstly confirmed by the system operator to avoid the risks. In the meanwhile, the real-time actions from existing AVC can also be used to quickly retrain the online DRL agent. It can be noted that the proposed control scheme is fully decentralized during execution, which can realize the regional AVC without any communication.

FIG. 3 illustrates an example of decentralized execution under heavy load condition in an experimental environment. It can be observed that agent 1 has several bus voltages (dots) dropping below the lower bound (a dash line) initialed, while agent 2 and 3 are fine. Once the agent 1 detects violations, its actor will output the control action to reset photovoltaic (PV) bus voltages (crosses) given its own observations (dots and crosses) while the actors of other agents remain the same. After control, the original violated voltages are regulated within the normal zone. As shown in FIG. 3, with the operation rule based policy, embodiments of the present disclosure can realize regional control, i.e., when the voltage violations occur in some agent's zone, the only one problematic agent needs to make a decision to reduce the voltage violations. As each agent in the multi-agent system just controls regional devices given the local measurements, the embodiments of the present disclosure can handle the high dimensional input-output space for the actor network thus solving a dimension cursing problem.

Although the above example illustrates a state violation as a voltage dropping below a predetermined lower bound. In other embodiments, a voltage rising above a predetermined upper bound is also considered a state violation.

FIG. 4 shows a flowchart illustrating a MA-AVC process for an electric power system according to an embodiment of the present disclosure. The MA-AVC process and system start with stage 1 operation in which a power grid is partitioned into different regions and assigned an artificial intelligent (AI) agent for each region in step 410. Then state information of the power grid is inputted to the MA-AVC system in step 420. The state information includes phasor measurement unit (PMU) and supervisory control and data acquisition (SCADA) measurements, such as bus voltage magnitude. In step 430, the MA-AVC system determines which AI agent(s) should take actions based on the input state information, e.g., a bus voltage violation. Then in step 440, the MA-AVC system generates actions by specific AI agent(s) using an exemplary DRL algorithm in stage 2 operation. In step 450, the MA-AVC system executes the generated actions in the power grid to reduce the bus voltage violation.

FIG. 5 shows a flowchart illustrating a power grid partitioning process, i.e., step 410 of the MA-AVC process of FIG. 4. The partitioning process first divides the power grid into several inter-connected regional zones according to default geographic location information in step 510. The partitioning process then assigns each AI agent a certain number of inter-connected zones using the geographic partition in step 520. In operation, some of the buses, generally sparse, based on the geographic partition may not significantly respond to corresponding local resources such as power generators, capacitor banks and transformers, controlled by the AI agent assigned to the zone. The partitioning process records these uncontrollable buses under certain AI agent(s) and re-assigns them to other effective AI agent(s) in post-partition adjustments in step 530. The post-partition adjustment process is repeated until all buses are under control by corresponding local resources in step 540.

FIG. 6 shows a flowchart illustrating a DRL training process, i.e., step 440 in the MA-AVC process of FIG. 4. The DRL training process starts with power flow initialization and DRL agent training initialization in step 610, in which observation of agent i(oᵢ^{t}) and the state of the environment (s^{t}) at a time step t are sent to each corresponding agent. In step 620, the agent in the zone with bus voltage violations generates suggested actions based on Algorithm 1. In step 630, the DRL training process executes the suggested actions in a power grid simulator and evaluates the actions with reward functions. In step 640, the DRL training process stores transition information into a replay buffer for each agent with bus voltage violations. The replay buffer is sampled in step 643, and the agent with violations is updated in step 646. The update includes actor, critic and coordinator updates. With the updated agent, the DRL training process returns to step 620 to suggest more actions for further reducing the bus voltage violation. In step 650, the DRL training process determines is the bus voltage violation is solved. If the violation is not solved, the DRL training process returns to step 620, otherwise the DRL training process advances to step 660 in which it moves to a next time step data and repeats steps 620 through 650 described above.

The MA-AVC system and method of the embodiment of the present disclosure may include software instructions including computer executable code located within a memory device that is operable in conjunction with appropriate hardware such as a processor and interface devices to implement the programmed instructions. The programmed instructions may, for instance, include one or more logical blocks of computer instructions, which may be organized as a routine, program, library, object, component and data structure, etc., that performs one or more tasks or performs desired data transformations. In an embodiment, generator bus voltage magnitude is chosen to maintain acceptable voltage profiles.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, Software modules or components may be located in local and/or remote memory storage devices. In addition, data being tied or rendered together in a database record may be resident in the same memory device, or across several memory devices, and may be linked together in fields of a record in a database across a network.

Section III. Numerical Simulation

The proposed MA-AVC scheme is numerically simulated on an Illinois 200-Bus system. The whole system is partitioned into three agents and formulated as a Markov Game with some specifications as shown in Table II. To mimic a real power system environment, an in-house developed power grid simulator is adapted to implement the AC power flow. The operating data are synthetically generated by applying random load changes and physical topology changes.

TABLE II
The Specification of Markov Game Constructed
in Illinois 200-Bus System

| Agent i | nᵢ^{b} | dim(aᵢ^{t}) | dim(oᵢ^{t}) | dim(Dᵢ) |
|---|---|---|---|---|
| #1 (Zone A F D1) | 106 | 15 | 106 | 690 |
| #2 (Zone B C D2) | 65 | 15 | 65 | 608 |
| #3 (Zone E D3) | 29 | 8 | 29 | 536 |

The neural network architecture of (target) actor, (target) critic, and coordinator for each agent are presented in the FIG. 7. Each block presents a fully connected layer. The batch normalization (BN) can be applied for the input. The Rectified Linear Unit (ReLU) and Sigmoid functions are selected as the activation functions. The number of neurons are labeled below each layer. During training, the Adam optimizer with a learning rate of 10⁻⁶, 10⁻⁶ and 10⁻⁵ for actor, critic, and coordinator, respectively, and the parameter 10⁻⁶ for updating the target networks are used. The discount factor γ, the size of the replay buffer, the batch size, and the maximum time steps are set to be 0.99, 200, 126, and 50, respectively. The exploration parameter σᵢ^{t} is decayed by 0.09% per time step. After all replay buffers are filled up, the network parameters are updated once every two-time steps if needed.

A. Case I: Without Contingencies

In case I, all lines and transformers are in normal working conditions and a strong centralized communication environment is utilized during training. The operation data have 70% 130% load change from its original base value, and the power generation is re-dispatched based on a participation factor. Three DRL based agents are trained on those first 2000 data, and tested on the remaining 3000 data. As shown in FIG. 8, as the training process continues, the actor loss defined as a negative performance measure and the critic loss of each agent has a downward tendency, and finally converges to an equilibrium solution. It can be observed in FIG. 9 that the total reward increases while the action time decreases, that is, each agent is trained to take as least as possible steps to reduce voltage violations. During testing, all agents only take one or two actions to fix the voltage problem. FIG. 10 shows that a level of cooperation βᵢ of each agent. They remain to be 0.5 at the beginning of training because the replay buffers have not been filled up and no network parameters are updated. Once network parameters start to update, the level of cooperation of each agent keeps adjusting based on the input state until three agents converge to an equilibrium solution. The CPU Time in FIG. 11 shows an obvious tendency to decrease along the training process.

B. Case II: With Contingencies

In case II, the same episodes and settings in case I are used during training, but random N−1 contingencies are considered as emergency conditions in real grid operation. One transmission line is randomly tripped during training, e.g., 108-75, 19-17, 26-25, 142-86. As shown in FIG. 12, both actor loss and critic loss of each agent perform a downward tendency, and finally converge to the equilibrium solution. It can be observed in FIG. 13 that the total reward increases and the action execution time decreases. During testing, all agents only take one or two actions to fix the voltage problem as well. FIG. 14 shows an update of cooperation level. Similarly, the CPU Time in FIG. 15 shows a decreasing tendency.

Both case I and case II demonstrate that the effectiveness of the proposed MA-AVC scheme for voltage regulation under the situation with/without contingencies.

C. Case III: With Weak Centralized Communication

The setting of case III is same as case II where N−1 contingencies are considered. But the communication graph among agents is not fully connected, namely weak centralized communication. We assume that agent #1 can communicate with agent #2 and #3, but agent #2 and #3 cannot communicate with each other. As shown in FIG. 16, during the training process, the actor loss and the critic loss of each agent have a downward tendency, and finally converge to the equilibrium solution. It can be observed in FIG. 17 that the total reward keeps increasing while the action time keeps decreasing along the training process. It should be noted that each agent takes a bit more action steps than that of case II, which means the limited communication does reduce the performance of system. Then, FIG. 18 and FIG. 19 show similar results as the previous cases.

From case III, it can be shown that the proposed MA-AVC scheme can perform well to reduce the voltage violations in a weak centralized communication environment with a bit more action times. It is a solid proof to extend the proposed algorithm to distributed training later. In addition, the level of cooperation in case I, II, and III have a similar tendency, that is, the cooperation level of agent 1 goes up while the cooperation level of agents 2 and 3 goes down. It indicates that the agent 1 have more potential to reduce voltage violations, and thus can contribute more in solving voltage issues.

D. Case IV: The Effect of Reward on Learning

In case IV, the effect of reward on motivating learning is studied. In the proposed reward design principle, a reward is assigned to each bus in terms of the deviation level of its magnitude from the given reference value. Although the major objective in this patent is to maintain acceptable voltage profiles, there is a concern whether the DRL based agent can autonomously learn to reduce the deviation of bus voltage magnitudes given a reference value. Case studies are performed with two different reference values: 1.0 pu and 0.96 pu. As shown in FIG. 20, the average voltage magnitude over each bus and sample on testing dataset is different. It can be further observed that the overall trend is toward the given reference, which demonstrates the ability of DRL based agent to reduce deviations and optimizes the voltage profile.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method for autonomous voltage control in an electric power system, the method comprising:
acquiring state information at buses of the electric power system;
detecting a state violation from the state information;
generating a first action setting based on the state violation using a predetermined algorithm by a first AI agent assigned to a first region of the electric power system where the state violation occurs; and
maintaining a second action setting by a second AI agent assigned to a second region of the electric power system where no substantial state violation is detected.

2. The method of claim 1, wherein the state information includes a bus voltage magnitude.

3. The method of claim 2, wherein the bus voltage magnitude is measured by a phasor measurement unit (PMU) or a supervisory control and data acquisition (SCADA) system coupled to the bus.

4. The method of claim 2, wherein the state violation includes the bus voltage magnitude dropping below a predetermined lower bound or rising above a predetermined upper bound.

5. The method of claim 1 further comprising executing the first action setting in the electric power system to reduce the state violation.

6. The method of claim 5, wherein the executing the first action setting includes changing a bus voltage of a power generator in the first region.

7. The method of claim 1, wherein the first region includes two or more geographical zones.

8. The method of claim 1 further comprising adjusting a partition of the electric power system by allocating a first bus from the first region to a third region of the plurality of regions, wherein the first bus is substantially uncontrollable by local resources in the first region and substantially controllable by local resources in the third region.

9. The method of claim 8, wherein the adjusting is repeated until all the buses in the first region is controllable by the local resources thereof.

10. The method of claim 1, wherein the predetermined algorithm is a deep reinforcement learning (DRL) algorithm.

11. The method of claim 10, wherein the generating the first action setting includes a training process comprising:
obtaining a first power flow file of the electric power system at a first time step;
obtaining an initial grid state from the first power flow file using a power grid simulator;
determining the state violation based on a deviation by the state information from the initial grid state;
generating a first suggested action based on the state violation;
executing the first suggested action in the power grid simulator to obtain a new grid state;
calculating and evaluating with a reward function according to the new grid state; and
determining if the state violation is solved,
wherein if the state violation is solved, the training process obtains a second power flow file at a second time step for another round of training process, and if the state violation is not solved, the training process generates a second suggested action by an updated version of the first AI agent.

12. The method of claim 11, wherein the training process further includes:
storing grid transition information into a replay buffer of the first AI agent; and
sampling the replay buffer to update the first AI agent.

13. A system for autonomous voltage control in an electric power system, the system comprising:
measurement devices coupled to buses of the electric power system for measuring state information at the buses;
a processor;
a computer-readable storage medium, comprising:
software instructions executable on the processor to perform operations, including:
acquiring state information from the measurement devices;
detecting a state violation from the state information;
generating a first action setting based on the state violation using a deep reinforcement learning (DRL) algorithm by a first AI agent assigned to a first region of the electric power system where the state violation occurs; and
maintaining a second action setting by a second AI agent assigned to a second region of the electric power system where no substantial state violation is detected.

14. The system of claim 13, wherein the state information includes a bus voltage magnitude.

15. The system of claim 13, wherein the measurement devices includes phasor measurement units (PMU) or a supervisory control and data acquisition (SCADA) system.

16. The system of claim 13, wherein the state violation includes a bus voltage magnitude dropping below a predetermined lower bound or rising above a predetermined upper bound.

17. The system of claim 13 further comprising executing the first action setting in the electric power system to reduce the state violation.

18. The system of claim 17, wherein the executing the first action setting includes changing a bus voltage of a power generator in the first region.

19. The system of claim 13 further comprising adjusting a partition of the electric power system by allocating a bus from the first region to a third region of the electric power system, wherein the bus is substantially uncontrollable by local resources in the first region, but substantially controllable by local resources in the third region.

20. The system of claim 19, wherein the adjusting is repeated until all the buses in the first region is controllable by the local resources thereof.

21. The system of claim 13, wherein the generating the first action setting includes a training process comprising:
obtaining a first power flow file of the electric power system at a first time step;
obtaining an initial grid state from the first power flow file using a power grid simulator;
determining the state violation based on a deviation by the state information from the initial grid state;
generating a first suggested action based on the state violation;
executing the first suggested action in the power grid simulator to obtain a new grid state;
calculating and evaluating with a reward function according to the new grid state; and
determining if the state violation is solved,
wherein if the state violation is solved, the training process obtains a second power flow file at a second time step for another round of training process, and if the state violation is not solved, the training process generates a second suggested action by an updated version of the first AI agent.

22. The system of claim 21, wherein the training process further includes:
storing grid transition information into a replay buffer of the first AI agent; and
sampling the replay buffer to update the first AI agent.

23. A method for autonomous voltage control in an electric power system, the method comprising:
acquiring state information at buses of the electric power system;
detecting a state violation from the state information;
generating a first action setting based on the state violation using a deep reinforcement learning (DRL) algorithm by a first AI agent assigned to a first region of the electric power system where the state violation occurs;
maintaining a second action setting by a second AI agent assigned to a second region of the electric power system where no substantial state violation is detected; and
executing the first action setting in the electric power system to reduce the state violation.

24. The method of claim 23 further comprising adjusting a partition of the electric power system by allocating a first bus from the first region to a third region of the plurality of regions, wherein the first bus is substantially uncontrollable by local resources in the first region and substantially controllable by local resources in the third region.

25. The method of claim 23, wherein the generating the first action setting includes a training process comprising:
obtaining a first power flow file of the electric power system at a first time step;
obtaining an initial grid state from the first power flow file using a power grid simulator;
determining the state violation based on a deviation by the state information from the initial grid state;
generating a first suggested action based on the state violation;
executing the first suggested action in the power grid simulator to obtain a new grid state;
calculating and evaluating with a reward function according to the new grid state; and
determining if the state violation is solved,
wherein if the state violation is solved, the training process obtains a second power flow file at a second time step for another round of training process, and if the state violation is not solved, the training process generates a second suggested action by an updated version of the first AI agent.

26. The method of claim 25, wherein the training process further includes:
storing grid transition information into a replay buffer of the first AI agent; and
sampling the replay buffer to update the first AI agent.
